(19) United States
(12) Patent Application Publication
(10) Pub. No.: US 2004/0228712 A1
(43) Pub. Date: Nov. 18, 2004

(54) Transfer apparatus and method for unloading semiconductor substrate from container

(76) Inventors: Seung-Man Nam, Gyeonggi-do (KR); Byeong-Ki Rheem, Gyeonggi-do (KR); Jin-Hyeung Jang, Gyeonggi-do (KR)

Correspondence Address: MARGER JOHNSON & McCOLLOM. P.C., 1030 S.W. Morrison Street, Portland, OR, 97205, US

(21) Appl. No.: 10/833,638

(22) Filed: Apr. 27, 2004

(30) Foreign Application Priority Data
May 14, 2003 (KR) 2003-30645

(51) Int. Cl. B65G 65/04

(52) U.S. Cl. 414/416.03

(57) ABSTRACT

A transfer apparatus includes a multi-arm apparatus, a controller, and a vacuum part. The multi-arm apparatus has a plurality of blades for vacuum-absorbing or vacuum-retaining a semiconductor substrate, a fixed body joined to each of blades, and a positioning apparatus joined to each fixed body for rotational or straight-line movement of the fixed body and the blades. The apparatus further includes vacuum lines that are formed within the multi-arm apparatus. The vacuum lines are selectively opened and closed. Even when there is a vacant slot in the FOUP, a plurality of wafers can be concurrently unloaded.

This U.S. non-provisional application claims priority from Korean patent application no. 2003-30645 filed on May 14, 2003, the contents of which are incorporated by reference in their entirety.

### FIELD OF THE INVENTION

The present invention relates to a wafer transfer apparatus and a wafer transfer method. More specifically, the present invention is directed to a transfer apparatus and method for unloading wafers from a container.

### BACKGROUND OF THE INVENTION

As the diameter of a wafer increases from 200 mm to 300 mm in recent years, a front open unified pod (hereinafter referred to as “FOUP”), which is a sealed type wafer container, has been used to protect wafers from atmospheric foreign substances or chemical contamination while transferring the wafers. As semiconductor chips are fabricated by a fully automatic system, the process equipment has an equipment front-end module (hereinafter referred to as “EFEM”) acting as an interface between a wafer container and a load lock chamber in the process equipment.

A transfer apparatus 800 has a transfer arm 810 for transferring a wafer provided in the EFEM. A vacuum line connected to a vacuum pump is formed in the transfer arm 810. A vacuum opening 812 for receiving a wafer is formed at the top of the transfer arm 810. A typical transfer apparatus 800 has only one transfer arm 810, as shown in FIG. 1, and transfers individual wafers from an FOUP to a load lock chamber one by one. However, because twenty five (25) slots are formed in the FOUP, and since wafers are inserted into the respective slots, a substantial amount of time is required for unloading wafers from the FOUP. Therefore, wafer throughput is reduced when the transfer apparatus 800 has only one transfer arm 810.

### SUMMARY OF THE INVENTION

A transfer apparatus for unloading semiconductor substrates from a container having a plurality of slots into which the semiconductor substrates are inserted comprises a multi-arm apparatus having a plurality of blades for vacuum-retaining of a plurality of semiconductor substrates, a fixed body joined to each of the blades, and a positioning apparatus joined to each fixed body for rotational or straight-line movement of the fixed body. The apparatus further includes vacuum lines formed within the multi-arm apparatus. The vacuum lines are selectively opened or closed. The apparatus also includes a controller for controlling the operation of the multi-arm apparatus and a vacuum source connected to the vacuum line.

According to another aspect of the present invention, a transfer method comprises checking a slot state of a container and determining whether there are unload-except semiconductor substrate in the container. If there is no unload-except substrate, the transfer method further comprises closing a solenoid valve connected to a vacuum line formed at a blade inserted into a vacant slot among the blades of the multi-arm apparatus and unloading a semiconductor substrate from the container by means of the multi-arm apparatus. If there is an unload-except substrate, the transfer method further comprises determining the number of process slots disposed between slots at which the unload-except substrate are placed is greater than the number of the blades of the multi-arm apparatus. If the number of the slots is greater than the number of the blades of the multi-arm apparatus, the substrate is unloaded by the multi-arm apparatus. If the number of the process slots is less than the number of the blades of the multi-arm apparatus, the substrate is unloaded by the single arm apparatus. The transfer method further comprises determining whether there is a vacant one of the process slots and closing a solenoid valve connected to a vacuum line formed at a blade corresponding to the vacant process slot in the multi-arm apparatus.

### BRIEF DESCRIPTION OF THE DRAWINGS

The above object and advantages of the present invention will become more apparent by describing in detail preferred embodiments thereof with reference to the attached drawings in which:

FIG. 1 is a perspective view of a typical transfer apparatus;

FIG. 2 is a front, partially broken view of semiconductor equipment employing a transfer apparatus according to an embodiment of the present invention;

FIG. 3 is a side, partially broken view of the EFEM shown in FIG. 2;

FIG. 4 and FIG. 5 are a perspective view and a top plan view, respectively, of the transfer apparatus according to an embodiment of the present invention;

FIG. 6 is a front view of a multi-arm apparatus shown in FIG. 4;

FIG. 7 is a sectional view depicting the vacuum lines in the multi-arm apparatus shown in FIG. 6;

FIG. 8 is a sectional view of a FOUP including a vacant slot that is employed in describing the operation of a multi-arm apparatus;

FIG. 9 is a front view of a single arm apparatus;

FIG. 10 is an FOUP having process slots describing the operation of a transfer apparatus according to an embodiment of the present invention; and

FIG. 11 is a flowchart for explaining a wafer transfer method using the transfer apparatus according to another embodiment of the present invention.

### DESCRIPTION OF THE PREFERRED EMBODIMENTS

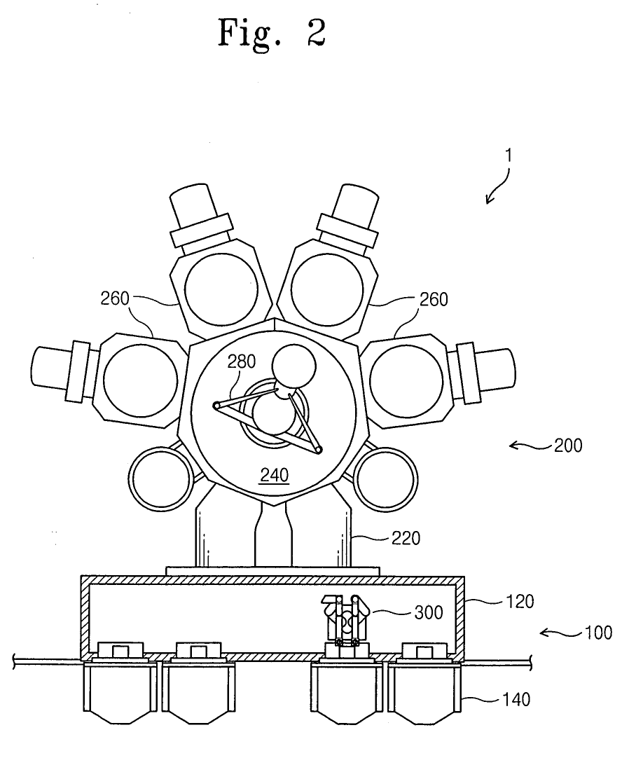

Referring to FIG. 2, a process apparatus 200, an EFEM 100, and an interface wall (not shown) are shown. The process apparatus 200 has at least one load lock chamber 220, a transfer chamber 240, and a plurality of process chambers 260. For example, the process chambers 260 may be a chemical vapor deposition (CVD) apparatus, a dry etch apparatus or a thermal furnace. A transfer chamber 240 is disposed at the center of the process chambers 260. A transfer robot 280 is installed at the transfer chamber 240 to transfer wafers between the load lock chamber 220 and the process chambers 260. The above process equipment 200 is maintained at a very high cleanliness level, as compared with the surrounding environment. The interface wall compartmentalizes the process chamber 200. An EFEM 100, acting as an interface between a wafer container for storing and transporting wafers, and the process equipment 200, are installed at one side of the process equipment 200.

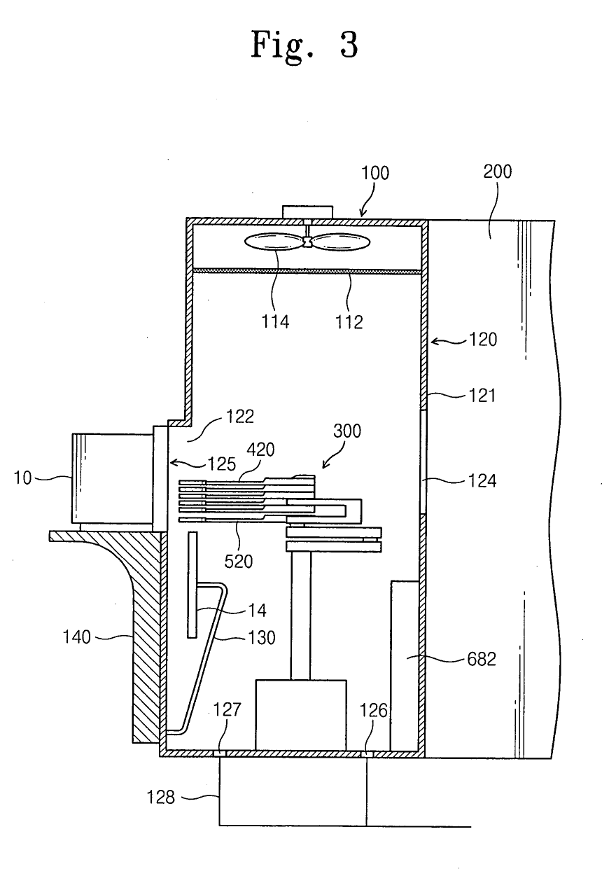

Referring to FIG. 3, the EFEM 100 includes a frame 120, a load station 140, and a transfer apparatus 300. The frame 120 preferably has a rectangular parallelepiped shape. A transportation opening 124 is formed at a rear face 121 that is adjacent to the process equipment 200. The transportation opening 124 provides a path for transporting a wafer between the frame 120 and the process equipment 200. To maintain the interior of the frame 120 in a continuous state of cleanliness, an air inflow opening 126 may be formed at an upper side of the frame 120, and an air outflow opening 127 may be formed at a lower side thereof. External air flows in through the air inflow opening 126, and the inflow air is exhausted through the outflow hole 127. A load station 140 is installed at one side of front face 122 that is opposite to the rear face 121 of the EFEM 100. A wafer container 10 is located on the load station 140. One load station 140 or more may be installed. The wafer container 10 may employ a front open unified pod (hereinafter referred to as “FOUP”) 1, which is a sealed type wafer carrier, so as to protect wafers from atmospheric foreign substances or chemical contamination while transferring the wafers 20. The FOUP 10 is loaded or unloaded by a carrier transfer system (not shown) such as an over head transfer (OHT), an overhead conveyor (OHC), or an automatic guided vehicle (AGV or RGV). An opener 130 for opening/closing a door 14 of the FOUP 10 loaded on the load station 140 is installed at the frame 120. When the door 14 of the FOUP 10 is opened by the opener 130, an opening 125 is formed at the front face 122 of the frame 120. Wafers are transferred through the opening 125.

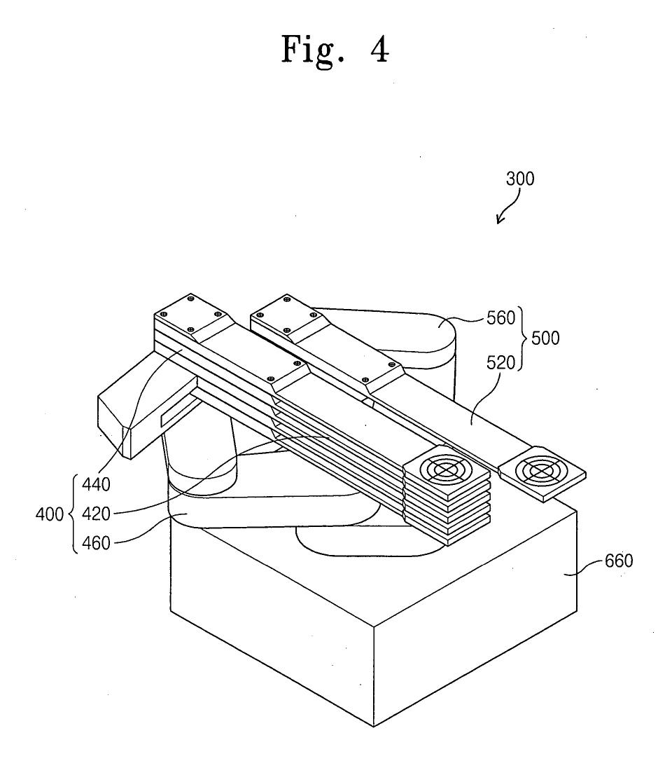

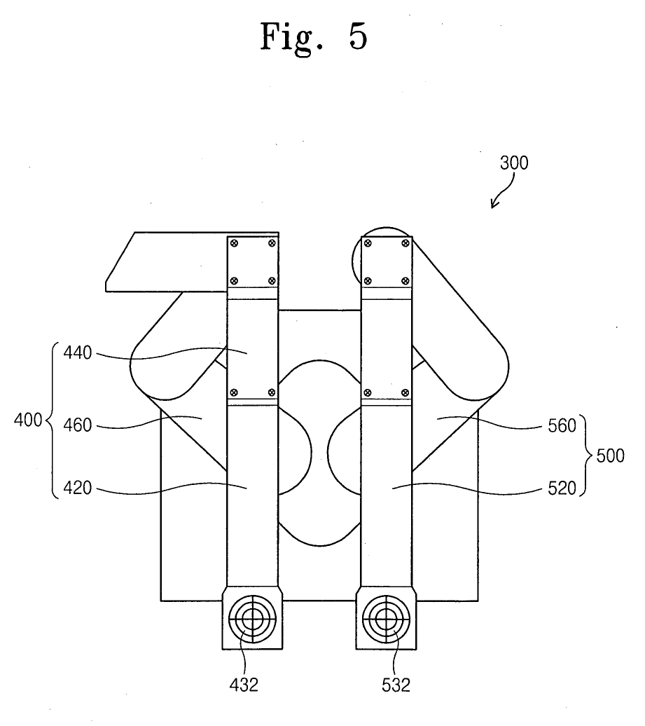

Referring to FIGS. 4 and 5, transfer apparatus 300 is disposed in the EFEM 100 to transfer wafers from the FOUP 10 to the load lock chamber 220 in the process equipment 200. Although blades 420 of a multi-arm apparatus, and a blade 520 of a single arm apparatus are illustrated side by side in FIG. 4 and FIG. 5, the blade 520 and the blades 420 are preferably disposed to be opposite, above and below each other. Referring to FIG. 4 and FIG. 5, a transfer apparatus 300 has a multi-arm apparatus 400 and a single arm apparatus 500. A base 660 is disposed at a lower portion in a frame. The multi-arm apparatus 400 and the single arm apparatus 500 are installed on the base 660.

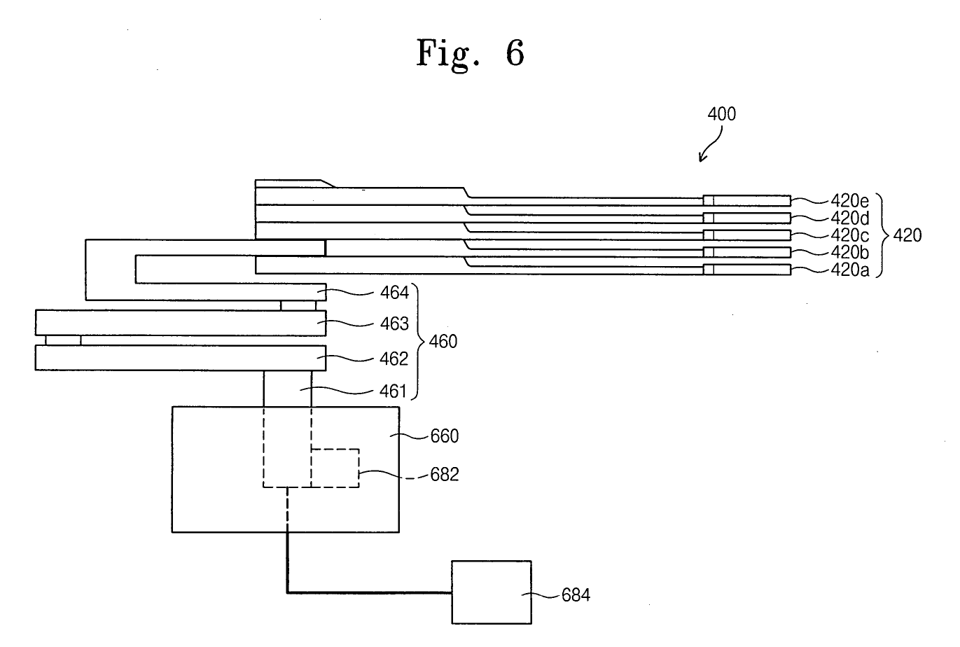

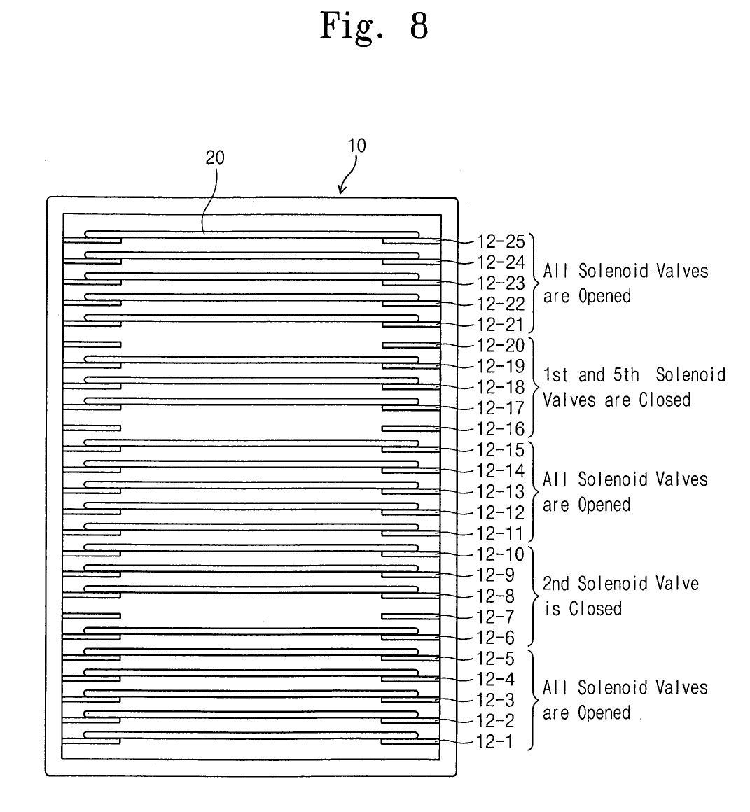

The multi-arm apparatus 400 concurrently transfers a plurality of wafers 20. Referring to FIG. 6, the multi-arm apparatus 400 has five blades 420, denoted as respective blades 420a-e, having the same general shape, a fixed body 440, and a fixed body positioning apparatus 460. Each of the blades 420 receives the wafers 20. The elongate blades 420 have a larger relative width and a smaller relative thickness. Further, each of the blades 420 is connected to one side of the fixed body 440 such that they are disposed in a stacked, spaced-apart arrangement. The space between the adjacent blades 420 is substantially equal to a space between slots 12 (FIG. 8) formed in the FOUP 10.

The fixed body positioning apparatus 460 is coupled below the fixed body 440 to move the fixed body 440 rotationally or in a straight line. The fixed body positioning apparatus 460 has a vertical positioning rod 461, a first arm 462, a second arm 463, and a third arm 464. The vertical positioning rod 461 is coupled to a hydraulic cylinder 682 disposed in the base 660. The hydraulic cylinder 682 drives the vertical positioning rod 461 to move up or down such that the blades 420 are located at heights corresponding to the vacant space in the slots 12 in the FOUP 10.

One end of the first arm 462 is axially coupled onto the vertical positioning rod 461, and one end of the second arm 463 is axially coupled onto the other end of the first arm 462. One end of the third arm 464 is axially coupled onto the other end of the first arm 462, and the other end of the third arm 464 is fixed to the fixed body 440. The first to third arms 462, 463, and 464 pivotally move on their respective coupling axes. Thus, the blades 420 connected to the fixed body 440 move into the FOUP 10 to remove wafers from the FOUP 10. Thereafter, the wafers are moved to the load lock chamber 220. While this embodiment has been described so that the multi-arm apparatus 400 has the five blades 420 and the positioning apparatus 460 has third arms, the number of the blades 420 and the actual number of arms may be varied.

A sensor (not shown) may be mounted onto the fixed body 440. The sensor checks the status of FOUP 10, e.g., the number of wafers placed into the slots. The results of the status check are transmitted to a controller 640. The controller 640 generally operates the system. For example, the controller 640 moves the positioning apparatus 460 and controls the operation of solenoid valve 480, as described below.

A vacuum opening 432 (FIG. 5) for absorbing and retaining the wafers 20 in a fixed position is formed at an upper portion of one end of the respective blades 420. A vacuum line 450 is formed in the respective blades 420, the fixed body 440, and the positioning apparatus 460 (FIG. 6).

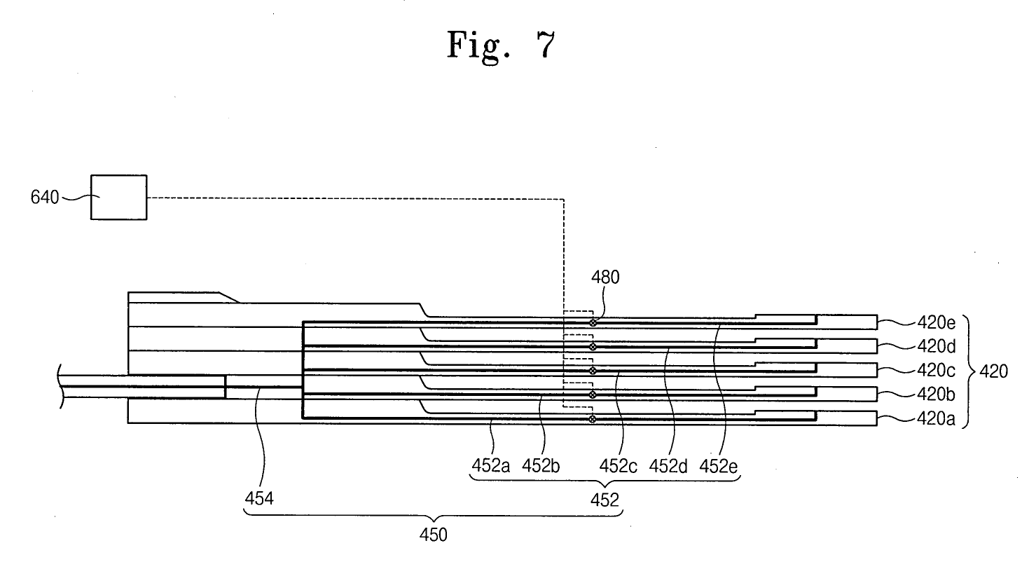

FIG. 7 is a cross-sectional view of the vacuum line 450 formed within the multi-arm apparatus 400. The vacuum line 450 includes a main line 454 formed at the positioning apparatus 460 and the fixed body 440 (FIG. 5), and a subline 452 branching out from the main line 454. Each of the branching sublines 452 is formed in the blade 420. A valve 480 for opening or closing the subline 452 is connected to the respective sublines 452. Although the valve 480 may comprise various types of valves, it preferably employs an electrically controllable solenoid valve. The main line 454 is formed only in the base 660. The sublines 452 are respectively formed within the blades 420 extending to the fixed body 440 and the positioning apparatus 460 and then coupled to the main line 454. If necessary, the sublines 452 formed within the blade 420 may be concurrently opened or closed.

If a transfer apparatus is used in which a solenoid valve is coupled only to a main line, and there is a vacant slot in the FOUP 10, there is a subline wherein a vacuum is not formed when wafers are placed on a vacuum opening of a blade. In this situation, the other blades cannot stably receive a wafer, so that the multi-arm apparatus 400 cannot be used to unload the wafer. However, if the solenoid valve 480 is connected to the respective sublines 452 as set forth in this embodiment, only the subline 452 formed in the blade 420 corresponding to a vacant slot will be closed. As a result, the multi-arm apparatus 400 may be used to unload the wafer.

FIG. 8 shows that about 25 slots are formed in the FOUP 10 and wafers 20 are inserted into the slots, respectively. From the bottom to the top of the FOUP 10, slots are sequentially defined as 1st slot 12-1, 2nd slot 12-2, . . . , and 25th slot 12-25. Blades are sequentially defined as 1st blade 420a, 2nd blade 420b, . . . , and 5th blade 420e. As shown in FIG. 8, wafers 20 are not inserted into the 7th, 16th, and 20th slots. When transferring wafers 20 are inserted into the 1st to 5th slots 12-1, 12-2, 12-3, 12-4, and 12-5, the 11th to 15th slots 12-11, 12-12, 12-13, 12-14, and 12-15, and the 21st to 25th slots 12-21, 12-22, 12-23, 12-24, and 12-25, the sublines 452 in all the blades 420 are opened. However, when transferring wafers 20 inserted into the 6th to 10th slots 12-6, 12-7, 12-8, 12-9, and 12-10, a vacuum line 452b formed in a second blade 420b is closed. When transferring wafers 20 inserted into the 16th to 20th slots 12-16, 12-17, 12-18, 12-19, and 12-20, vacuum lines 452a and 452e formed in the first and fifth blades 420a and 420e are closed.

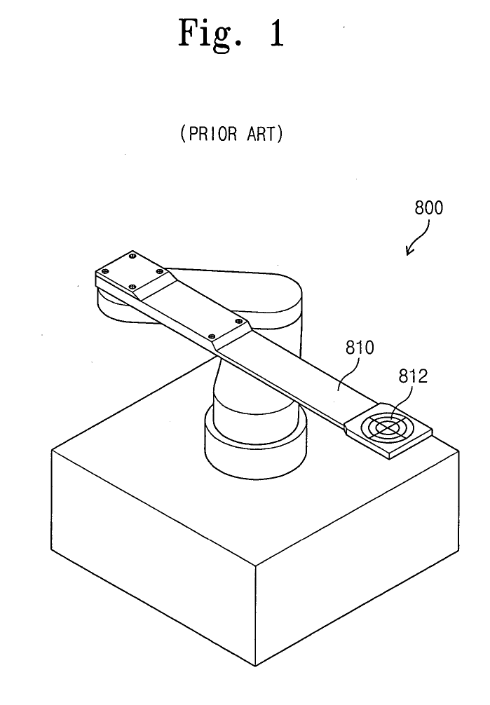

Returning to FIG. 1, the transfer apparatus 300 has a single arm apparatus 500. In any process, it is often necessary that wafers 20 in the FOUP 10 are all not unloaded and a few wafers are used as samples or only reprocess-required wafers are transferred. The single arm apparatus 500 may be used to unload a specific wafer, as in this case.

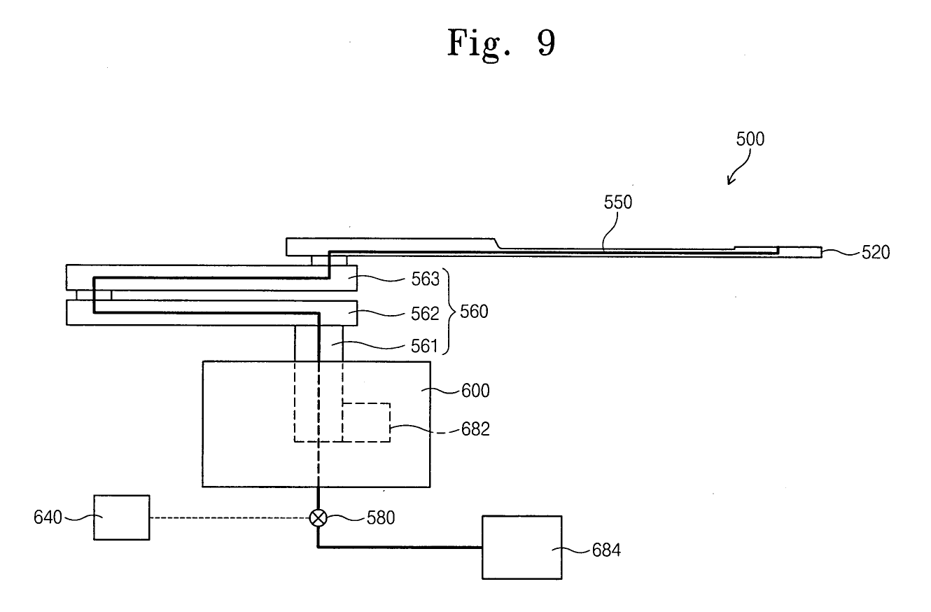

Referring to FIG. 9, the single arm 500 has a single blade 520 and a single arm positioning apparatus 560 for moving the blade 520. The single arm positioning apparatus 560 has a vertically extending positioning rod 561, a first arm 562, and a second arm 563 fixed to the blade 520. The single arm positioning apparatus 560 has a similar structure and function to the fixed positioning apparatus 460, except that the vertical positioning rod 561 is fixed to the blade 520.

A vacuum line 550 is formed in the blade 520 and the single arm positioning apparatus 560 is coupled to a vacuum pump 684. A solenoid valve 580 for opening or closing the vacuum line 550 is connected to the vacuum line 550. If necessary, one or a plurality of single arm apparatus 500 may be installed.

If the number of wafers to be transferred is more than the number of blades 420 of the multi-arm apparatus 400, and the wafers 20 are located in successive slots, they are preferably unloaded by the multi-arm apparatus 400. If wafers to be transferred are not successively located, they are preferably unloaded by the single arm apparatus 500.

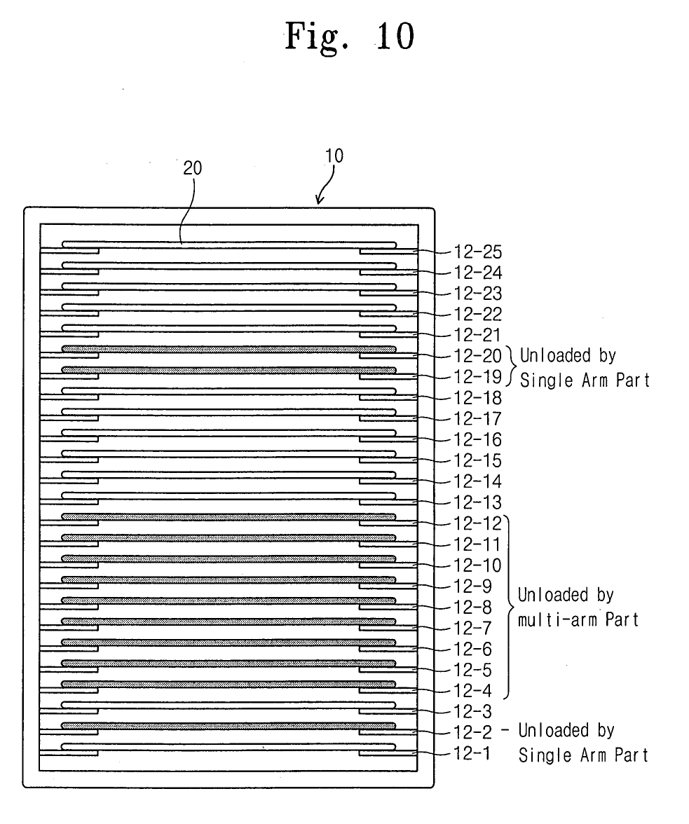

In FIG. 10, wafers 20 indicated by an oblique line are to be unloaded, the other wafers 20 are not to be unloaded. If only the wafers 20 disposed at slot 12-2, the 4th to 12th slots (12-4 through 12-12), the 19th slot (12-19), and the 20th slot (12-20) are unloaded, the wafers 20 disposed at slot 12-2, slot 12-19, and slot 12-20 are unloaded by the single arm apparatus 500. The wafers 20 disposed at slots 12-4 through 12-12 may be unloaded by the multi-arm apparatus 400.

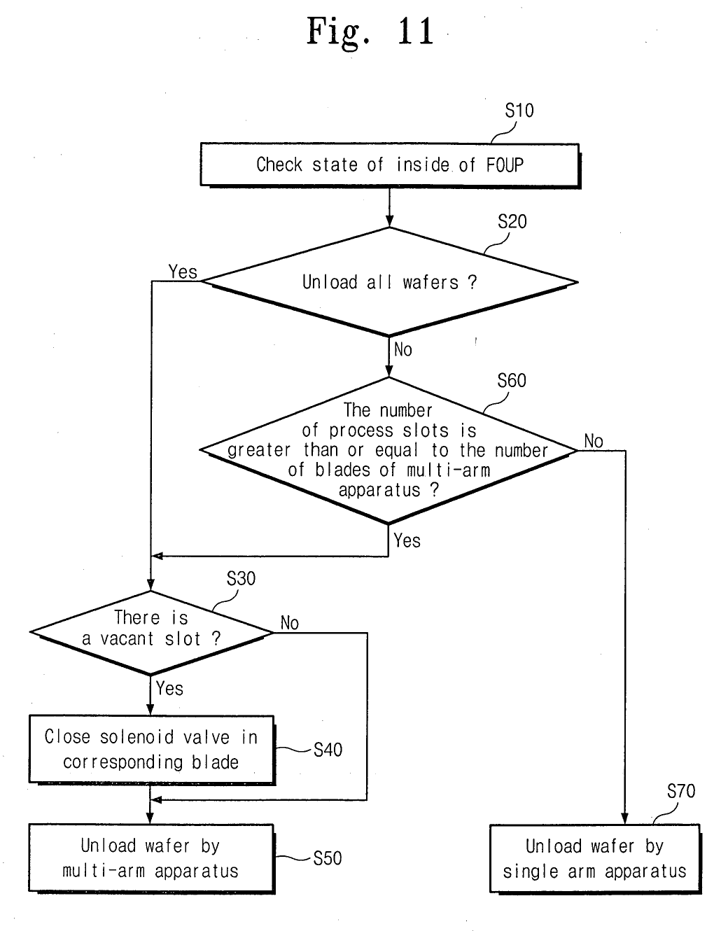

A flowchart for explaining a wafer transfer method using the transfer apparatus according to an embodiment of the present invention is illustrated in FIG. 11. Referring to FIG. 11, when the FOUP is placed on the load station 140 and its cover 14 is opened, the transfer apparatus 200 moves up and down so that the sensor checks the status of the interior of the FOUP. The result checked by a sensor is transmitted to the controller 640 (S 10). The controller 640 determines whether all wafers 20 in the FOUP are unloaded or only a single wafer 20 disposed at a specific position is unloaded (S20).

If it is determined that all wafers 20 in the FOUP are to be unloaded, they are unloaded by the multi-arm apparatus 40. In the FOUP, if a slot on which the wafer 20 is placed is called a transfer slot, and a slot on which a wafer 20 is not placed is called a vacant slot, it is determined whether slots unloaded at one time by a multi-arm apparatus are all transfer slots (S30).

If all slots are transfer slots, they are unloaded by the multi-arm apparatus (S50). At this time, all solenoid valves are in an open state. But if there is a vacant slot among the slots unloaded at one time by the multi-arm apparatus 40, the controller 640 sends a signal to a solenoid valve so as to close a subline 450 formed at a corresponding blade 420 (S40). Thereafter, the wafer 20 is unloaded by the multi-arm apparatus (S50).

If it is determined that only the wafers disposed at slots of predetermined positions in the FOUP (“process slots”) are to be transferred, the controller 640 determines whether the number of successively disposed process slots is greater than the number of the blades 420 of the multi-arm apparatus 400 (five blades in this embodiment) (S60).

If the number of the successively disposed process slots is greater than the number of the blades 420 of the multi-arm apparatus, and if there is no vacant slot, the wafers are unloaded by the multi-arm apparatus 400. If there is a vacant slot, the wafer 10 is unloaded after closing the vacuum line 450 formed at the corresponding blade 420. If the number of the successively disposed process slots is smaller than the number of the blades 420 of the multi-arm apparatus, the wafers may be unloaded by the single arm apparatus 500 (S70).

According to an embodiment of the present invention, a plurality of wafers 20 from the FOUP 10 can be concurrently unloaded to shorten time required for unloading wafers. Further, although there is a vacant slot in the FOUP, the plurality of the wafers can be concurrently unloaded. Also, only the wafers disposed at specific slots in the FOUP can be unloaded.

While the invention has been disclosed in its preferred form, the specific embodiments thereof as disclosed and illustrated herein are not to be considered in a limiting sense. Indeed, it should be readily apparent to those skilled in the art in view that various changes in form and details may be made therein without departing from the spirit and scope of the invention as defined by the appended claims and their equivalents.

What is claimed is:

1. A transfer apparatus for unloading semiconductor substrates from a container having a plurality of slots into which the semiconductor substrates are inserted, the transfer apparatus comprising:
a multi-arm apparatus having a plurality of blades for vacuum-retaining of a plurality of semiconductor substrates;
vacuum lines formed within the multi-arm apparatus, the vacuum lines being selectively opened or closed;
a controller for controlling the operation of the multi-arm apparatus; and
a vacuum source connected to the vacuum line.

2. The transfer apparatus of claim 1, further comprising a fixed body joined to each of the blades, and a positioning apparatus joined to each fixed body for rotational or straight-line movement of the fixed body.

3. The transfer apparatus of claim 1, wherein the vacuum lines comprise:
a main line connected to the vacuum source;
sublines extending from the main line located within the blades; and a control valve connected to the sublines.

4. The transfer apparatus of claim 3, wherein the control valve is a solenoid value.

5. The transfer apparatus of claim 1, further comprising a single arm apparatus having a blade for vacuum-retaining the semiconductor substrate, and a positioning apparatus for rotational or straight-line movement of the blade, wherein a vacuum line is located in the single arm apparatus.

6. The transfer apparatus of claim 1, wherein the blades are disposed in a stacked, spaced-apart arrangement.

7. The transfer apparatus of claim 1, wherein the multi-arm apparatus concurrently transfers a plurality of semiconductor substrates.

8. The transfer apparatus of claim 1, wherein the blades are located at heights corresponding to the location of slots disposed in a front open unified pod (FOUP).

9. A transfer apparatus for unloading a semiconductor substrate from a container having a plurality of slots located therewithin, the transfer apparatus comprising:
a multi-arm apparatus having a plurality of movable blades for unloading a plurality of semiconductor substrates from the container;
a single arm apparatus having a blade for unloading a semiconductor substrate from one of the slots; and
a controller for controlling the operations of the multi-arm apparatus and the single arm apparatus.

10. The transfer apparatus of claim 9, which further comprises:
a vacuum source;
a main vacuum line connected to the vacuum source;
vacuum sublines extending from the main line located within the blades; and
a control valve connected to the sublines.

11. The transfer apparatus of claim 10, wherein the control valve is a solenoid value.

12. The transfer apparatus of claim 9, further comprising a positioning apparatus for rotational or straight-line movement of the blades.

13. The transfer apparatus of claim 9, wherein the blades are disposed in a stacked, spaced-apart arrangement.

14. The transfer apparatus of claim 9, wherein the multi-arm apparatus concurrently transfers a plurality of semiconductor substrates.

15. The transfer apparatus of claim 9, wherein the blades are located at heights corresponding to the location of slots disposed in a FOUP.

16. A transfer method for unloading a plurality of semiconductor substrates, from a container having a plurality of slots into which the semiconductor substrates are inserted, the method comprising:
monitoring the status of slots to determine if the semiconductor substrates are located therein;
providing a multi-arm apparatus having a plurality of blades for vacuum retaining the semiconductor substrates; and
unloading the semiconductor substrates from the container using the multi-arm apparatus.

17. The transfer method of claim 16, further comprising:
inserting a blade into a vacant slot; and
closing a vacuum line formed in the blade inserted into the vacant slot.

18. A transfer method for unloading a plurality of semiconductor substrates, from a container having a plurality of successively disposed process slots into which the semiconductor substrates are inserted, the method comprising:
providing a multi-arm apparatus having a plurality of blades for vacuum retaining the semiconductor substrates;
providing a single-arm apparatus having a single blade for vacuum retaining one of the plurality of the semiconductor substrates;
unloading the substrates, using the multi-arm apparatus, if the number of the successively disposed process slots is greater than or equal to the number of the blades of the multi-arm apparatus; and
unloading the substrate, using the single arm apparatus, if the number of the successively disposed process slots is less than the number of the blades of the multi-arm apparatus.

19. The transfer method of claim 18, further comprising:
determining whether there is a vacant one of the slots; and
closing a control valve connected to a vacuum line formed at a blade corresponding to the vacant slot in the multi-arm apparatus.

20. The transfer method of claim 18, wherein the blades are disposed in a stacked, spaced-apart arrangement.

21. The transfer method of claim 18, wherein the multi-arm apparatus concurrently transfers a plurality of semiconductor substrates.

22. The transfer method of claim 18, wherein the blades are located at heights corresponding to the location of slots disposed in a FOUP.
